(19) United States
(12) Patent Application Publication
(10) Pub. No.: US 2015/0099285 A1
(43) Pub. Date: Apr. 9, 2015

(54) Systems and Methods for Producing Energy

(71) Applicants: Steven M. Clements, McHenry, IL (US); Richard L. Clements, McHenry, IL (US)

(72) Inventors: Steven M. Clements, McHenry, IL (US); Richard L. Clements, McHenry, IL (US)

(21) Appl. No.: 14/462,143

(22) Filed: Aug. 18, 2014

Related U.S. Application Data
(60) Provisional application No. 61/886,671, filed on Oct. 4, 2013.

(51) Int. Cl. C10G 1/04; C10L 1/02; H02K 7/18; C10L 1/00

(52) U.S. Cl. CPC C10G 1/045; C10L 1/00; C10L 1/02; H02K 7/1807; C10L 2200/0469; C10L 2270/026
USPC 435/165; 585/240; 585/242; 422/187; 585/241; 435/289.1; 290/1 R

(57) ABSTRACT

The present invention relates to systems and methods for producing energy. Specifically, the present invention relates to systems and methods for producing energy, such as energy in the form of electricity, and fuels, such as, for example, biodiesel and/or cellulosic ethanol in a small scale energy center. Moreover, the systems and methods of the present invention provide for recovery of materials, such as in soil production and/or recycling.

The present invention claims priority to U.S. Provisional Pat. App. No. 61/866,671, titled “Systems and Methods for Producing Energy”, filed Aug. 16, 2013, which is incorporated herein by reference in its entirety.

### TECHNICAL FIELD

The present invention relates to systems and methods for producing energy. Specifically, the present invention relates to systems and methods for producing energy, such as energy in the form of electricity, and fuels, such as, for example, biodiesel and/or cellulosic ethanol in small scale energy centers. Moreover, the systems and methods of the present invention provide for recovery of materials, such as in soil production and/or recycling.

### BACKGROUND

Production of energy is well-known in this country and around the world. Indeed, typical sources of energy include mining or drilling processes that obtain solid or liquid energy sources in the form of coal, oil, natural gas, nuclear material and other like products that can be used as an energy source for producing power, in the form of heat, electricity, and other like energy products.

To a great extent, readily available forms of energy, in the form of oil, for example, are imported into the United States from other countries, many of them relatively hostile to United States policies. Dependency on foreign sources of energy allows the United States to be subject to foreign manipulation, not only in energy prices, but global policy matters and issues. A need exists for systems and methods for producing energy that reduce or eliminate U.S. dependency on foreign energy sources.

The United States does not import all of its energy needs. Indeed, there are many domestic energy production programs including drilling and mining in the United States. Indeed, hydraulic fracking, which is the insertion of pressurized fluids into wells to break up rocks and sand for easier removal of liquid and gas energy sources, provides access to many more sources of domestic energy production. However, whether drilling or mining for energy sources, the fact remains that these energy sources are typically not replenished, and the total amount of energy production is necessarily limited. Once these sources run out, the energy will be gone forever. A need exists, therefore, for systems and methods for producing energy that may be replenished or come from renewal sources.

Moreover, mining and drilling have a lasting effect on ecosystems and the environment. Mines and wells typically scar the landscape. Moreover, voids may be created underground that may contribute to instability of earth in and around the mines and wells. Earthquakes have been attributed to mining activities. A need, therefore, exists for systems and methods for producing energy that is friendly to the environment.

Recently, biofuel production has become another source of energy production in the United States and around the world. Specifically, biofuel is created using biomass that may be converted to energy, either to electricity or to liquid or gas energy sources, such as biodiesel or cellulosic ethanol. Biomass may include forestry crops, agricultural crops, sewage, industrial resources, animal residues, municipal solid waste, and other biomass sources.

Biofuel production typically involves the breakdown of biomass into biofuel using enzymes and/or other chemicals. As noted above, fuel that may be used in the production of electricity, or in the production of biodiesel and/or cellulosic ethanol is typically produced from biomass. Typically, however, large-scale biofuel production facilities have been built in locations that are large distances from biomass sources, which bring large volumes of truck traffic that may tax local infrastructure, and may add to transportation costs to feedstock costs. Alternatively, large-scale production facilities may be built in areas where local feedstocks may be sources, but delivery of biofuel typically requires transportation over hundreds if not thousands of miles to users of the biofuel. Thus, transportation costs contribute to high production and delivery costs. A need, therefore, exists for systems and methods for producing energy that reduce transportation costs of both biomass sources and biofuel delivery.

In addition, small scale energy production facilities may typically lack sufficient production to generate requisite return on investment and profitability to make these small scale energy production facilities economically viable, and therefore, such small scale production facilities have struggled to be the proper pathway to commercialization of the industry.

Moreover, typical fuel production facilities have many inefficiencies. Typically, biofuel production facilities may focus on the production of only one energy source, whether direct energy production, such as in the form of electricity, or the creation of biodiesel or cellulosic ethanol. A need exists for systems and methods that provide efficient creation of alternative energy sources in the form of electricity, biodiesel and cellulosic ethanol. In other words, a need exists for systems and methods that combine the production of electricity, biodiesel and cellulosic ethanol in one overall system.

Typically, biomass that may be used for biofuel production may be landfilled, taking up valuable space. A need exists for systems and methods for producing energy that reduces landfilling of materials. In addition, biomass may come from forestry crops. Proper maintenance and care of national forests including the removal of biomass therefrom by proper thinning of forested areas may decrease devastating forest fires.

An advantage of using biofuels is the reduction of harmful elements and compounds, such as sulfur, for example, from waste streams. Biofuels are typically free of sulfur and many other harmful chemicals that may impact the quality of breathable air.

Moreover, many large scale biofuel production facilities lack the necessary sorting and separating that may be required for use in different biofuel production streams. Moreover, many large scale biofuel production facilities lack the capacity to separate materials that may be utilized as soil enhancements or additives, or for recycling.

### SUMMARY OF THE INVENTION

The present invention relates to systems and methods for producing energy.

Specifically, the present invention relates to systems and methods for producing energy, such as energy in the form of electricity, and fuels, such as, for example, biodiesel and/or cellulosic ethanol in small scale energy centers. Moreover, the systems and methods of the present invention provide for recovery of materials, such as in soil production and/or recycling.

To this end, in an embodiment of the present invention, a system for producing energy in the form of electricity, biodiesel and cellulosic ethanol is provided. The system comprises: a feedstock module for obtaining biomass feedstock; a sorting module for separating the feedstock into a plurality of feedstock lines including an electric power feedstock line, a biodiesel feedstock line and a cellulosic ethanol feedstock line; an electric power module for converting the feedstock from the electric power feedstock line into electricity; a biodiesel module for converting the feedstock from the biodiesel feedstock line into biodiesel; and a cellulosic ethanol module for converting the feedstock from the cellulosic ethanol feedstock line into cellulosic ethanol. In an optional embodiment, modules of the present invention may be mobile.

Moreover, in an alternate embodiment of the present invention, a method for producing energy in the form of electricity, biodiesel and cellulosic ethanol is provided. The method comprises the steps of: obtaining biomass feedstock from a local area; separating the feedstock into a plurality of feedstock lines including an electric power feedstock line, a biodiesel feedstock line and a cellulosic ethanol feedstock line; converting the feedstock from the electric power feedstock line into electricity; converting the feedstock from the biodiesel feedstock line into biodiesel; and converting the feedstock from the cellulosic ethanol feedstock line into cellulosic ethanol.

It is, therefore, an advantage and objective of the present invention to provide systems and methods for producing energy that reduce or eliminate U.S. dependency on foreign energy sources.

In addition, it is an advantage and objective of the present invention to provide systems and methods for producing energy that may be replenished or come from renewable sources.

Moreover, it is an advantage and objective of the present invention to provide systems and methods for producing energy that is friendly to the environment.

Further, it is an advantage and objective of the present invention to provide systems and methods for producing energy that reduce transportation costs of both biomass sources and biofuel delivery.

Still further, it is an advantage and objective of the present invention to provide systems and methods that provide efficient creation of alternative energy sources in the form of electricity, biodiesel and cellulosic ethanol. In other words, it is an advantage and objective of the present invention to provide systems and methods that combine the production of electricity, biodiesel and cellulosic ethanol into one overall system.

In addition, it is an advantage and objective of the present invention to provide systems and methods for producing energy that reduces landfilling of materials.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a small scale energy center system in an embodiment of the present invention.

FIG. 2 illustrates a method of producing energy in a small scale energy center in an embodiment of the present invention.

### DETAILED DESCRIPTION OF THE PRESENTLY PREFERRED EMBODIMENTS

The present invention relates to systems and methods for producing energy. Specifically, the present invention relates to systems and methods for producing energy, such as energy in the form of electricity, and fuels, such as, for example, biodiesel and/or cellulosic ethanol in a small scale energy center. Moreover, the systems and methods of the present invention provide for recovery of materials, such as in soil production and/or recycling.

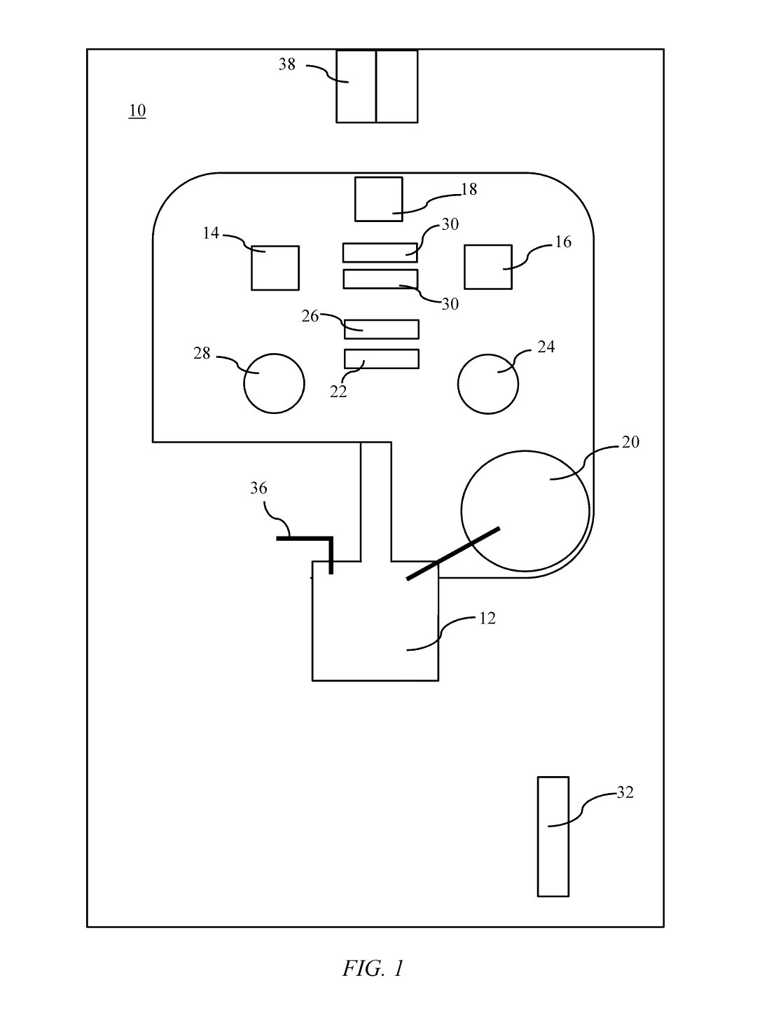

Now referring to the figures, wherein like numerals refer to like parts, FIG. 1 illustrates a small scale energy center 10 in an embodiment of the present invention. The center 10 may comprise a handling center module 12 that may be connected in process flow to a plurality of energy generators 14, 16 18. Specifically, energy generator 14 may be a cellulosic ethanol plant that may generate cellulosic ethanol from biomass. Energy generator 16 may be a biodiesel plant that may generate biodiesel from biomass. Moreover, energy generator 18 may be an electricity generator that may generate electricity from biomass.

It should be noted that the present invention, as disclosed herein, specifically describes generation of both cellulosic ethanol and biodiesel, as well as electricity production; however, the present invention may also include other biofuels, including other advanced biofuels that may be generated from the biomass disclosed herein, and the present invention should not be limited as described.

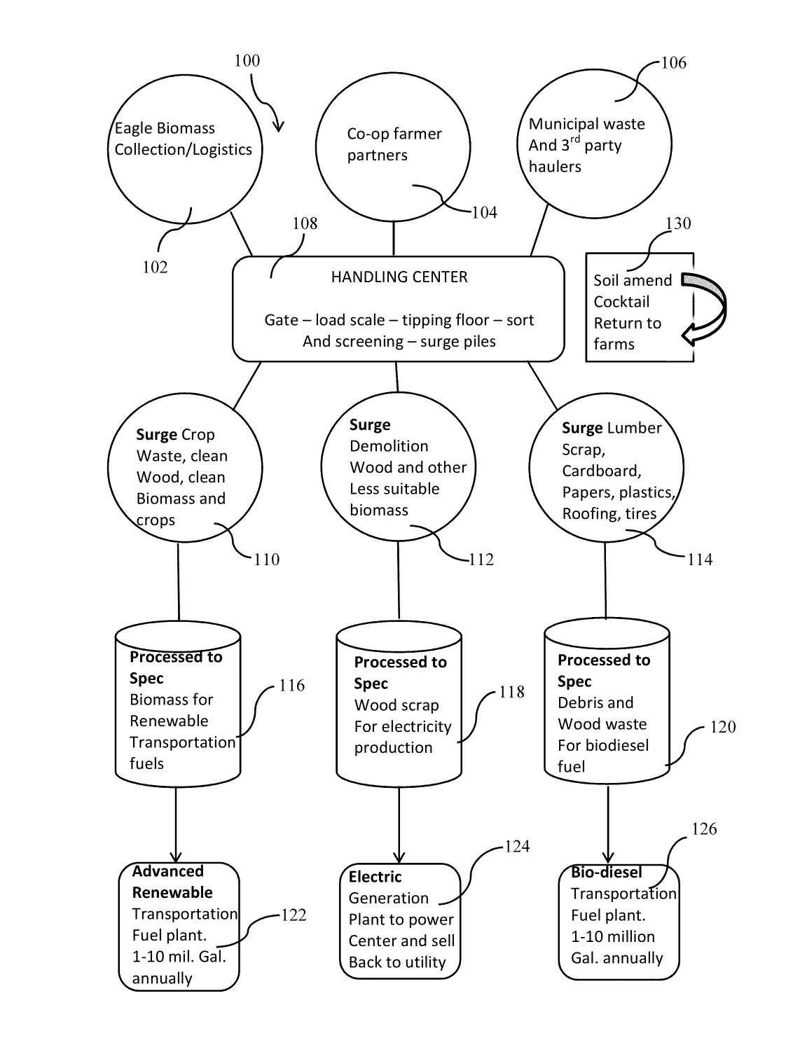

Handling center module 12 may allow for the delivery of biomass thereto, such as via delivery by truckload, by train, or via any other delivery method, as illustrated in method 100 shown in FIG. 2, steps 102, 104 and 106. Specifically, as illustrated in steps 102, 104, 106, biomass may be delivered from a plurality of sources, such as from construction demolition and cleanup (via step 102), from crop waste and designated fuel crops, whether processed or unprocessed (via step 104) and/or via municipal waste and/or third party handlers, delivering landscape waste, tree waste, other bulky waste that may be suitable for feedstock or recycling (via step 106).

It should be noted that biomass that may be delivered to the small scale energy center 10 may be processed to some degree prior to delivery to the small scale energy center 10. For example, certain biomass may be separated prior to delivery, or ground, chipped, reduced in size, or the like.

Once delivered to the handling center 12 (via step 108), via one or more bays, the delivered biomass may be sorted on a sorting platform that may be contained within the handling center 12. Biomass may be delivered to a biomass surge pile 20 via a conveyor. The biomass surge pile 20 may simply be a pile of sorted biomass useful for energy production, as described herein. There may be separate biomass surge piles for the specific energy desired to be produced. Specifically, a surge pile for ethanol production may be produced, via step 110. A surge pile for electricity production may be produced, via step 112. And a surge pile for biodiesel production may be produced, via step 114.

The biomass may be processed into a usable form for generating energy, either into cellulosic ethanol, biodiesel or electricity, as the case may be, via steps 116, 118 and 120. The biomass contained in the biomass surge pile 20 may be processed via a primary grind module 22 into a primary specification, and stored in a primary spec pile 24. From there, the biomass may be processed via a specification grind module 26 and stored in a finish spec pile 28. From there, the biomass may be added to the energy generators 14, 16 or 18, depending on its type of quality.

The cellulosic ethanol generator 14 may take in requisite biomass that may be useful for generating cellulosic ethanol, such as crop waste, clean wood and other like clean biomass and crops. Enzymes necessary for ethanol production may be used in the cellulosic ethanol generator 14 as apparent to one of ordinary skill in the art. Specifically, the ethanol generator 14 may contain a vat, a tank or a plurality of vats or tanks that may contain the proper chemistry, including the proper enzymes, for breaking the requisite biomass down into cellulosic ethanol. The cellulosic ethanol may be collected and used as an energy source, as illustrated in step 122. For example, the cellulosic ethanol may be used as a transportation fuel, or any other type of fuel apparent to one of ordinary skill in the art. Specifically, the cellulosic ethanol generated by the systems and methods described herein may be delivered locally for use, thereby minimizing transportation costs.

The biodiesel generator 16 may take in requisite biomass that may be useful for generating biodiesel, such as lumber scrap, cardboard, papers, plastics, roofing, tires, or other like material. Specific chemicals and processes for biodiesel production may be used in the biodiesel generator 16 as apparent to one of ordinary skill in the art. Specifically, the biodiesel generator 16 may contain a vat, a tank or a plurality of vats or tanks that may contain the proper chemistry for breaking the requisite biomass down in to biodiesel. The biodiesel may be collected and used as an energy source, as illustrated in FIG. 2 in step 126. For example, the biodiesel may be used as a transportation fuel, or any other type of fuel apparent to one of ordinary skill in the art. Specifically, the biodiesel generated by the systems and methods described herein may be delivered locally for use, thereby minimizing transportation costs.

The electricity generator 18 may take in requisite biomass that may be useful for generating electricity, such as demolition wood and other less suitable biomass. This biomass may be converted to electricity by, for example, burning the same in one or more electricity generators 30, as apparent to one of ordinary skill in the art. Electricity generated thereby may be utilized locally, such as within the plant for running the electrical systems thereof, and/or may be sold back to the electric utility, via step 124.

The small scale energy center 10 may further have other optional components, such as a truck scale 32 to measure the weight of trucks delivering biomass to the facility, both for tracking the amount of biomass delivered thereto and optionally to provide payment for delivery thereof.

Once the biomass delivered to the handling center module 12, the biomass may be sorted into the biomass surge pile 20, as described above, and into other streams, such as sorting of fines 34, and the separation of plastics or other materials that may be utilized to recycle the same, as indicated in module 36. Materials that may be useful as soil enhancers or additives, such as, for example, plant fly ash, gypsum, low yield biomass, sawdust, compost, and other like materials, may be collected and delivered to local farms, via step 130.

The present invention may be implemented in a modular structure, making it simple and relatively easy to construct where needed. Specifically, a large number of small scale energy centers, as described herein, may be placed as necessary in various locations, such as in or near more populated regions adjacent to agriculture land, to minimize transportation costs both of delivery of biomass to the energy centers, and of delivery of the energy sources generated thereby. In an alternate embodiment, the small scale energy centers, as described herein, may be deployed in a mobile fashion, having modules and a system that is easily movable from one location to another. For example, the handling center 10 and/or grinder modules, generator modules, and other like components described herein may be mobile.

Specifically, the particular components of the systems disclosed herein may be placed on trucks, trains, and/or other like vehicles for transportation of the components to locations where the small scale energy center may be deployed in a mobile fashion. For example, a storm or other catastrophe may generate biomass caused by downed trees, ruined crops, ruined homes and other buildings, or other like biomass. Mobile deployment of the components of the present invention may allow the relatively quick and efficient disposition of a small scale energy center at or near the biomass caused by the storm or other catastrophe.

In implementation, the biomass may be collected by mobile collection vehicles that may allow for delivery to mobile sorters and processors that may also be implemented on mobile vehicles, such as trucks, trains or other like vehicles. Thus, each of the components may be moved to or relatively close to the biomass, thereby decreasing transportation costs of moving the biomass to the facilities for processing.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A system for producing energy in the form of electricity, biodiesel and cellulosic ethanol comprising:
a feedstock module for obtaining biomass feedstock;
a sorting module for separating the feedstock into a plurality of feedstock lines including an electric power feedstock line, a biodiesel feedstock line and a cellulosic ethanol feedstock line;
an electric power module for converting the feedstock from the electric power feedstock line into electricity;
a biodiesel module for converting the feedstock from the biodiesel feedstock line into biodiesel; and
a cellulosic ethanol module for converting the feedstock from the cellulosic ethanol feedstock line into cellulosic ethanol.

2. The system of claim 1 wherein the system is mobile.

3. A method for producing energy in the form of electricity, biodiesel and cellulosic ethanol comprising the steps of:
obtaining biomass feedstock from a local area;
separating the feedstock into a plurality of feedstock lines including an electric power feedstock line, a biodiesel feedstock line and a cellulosic ethanol feedstock line;
converting the feedstock from the electric power feedstock line into electricity;
converting the feedstock from the biodiesel feedstock line into biodiesel; and
converting the feedstock from the cellulosic ethanol feedstock line into cellulosic ethanol.

4. The method of claim 3 wherein the plurality of feedstock lines are mobile.
